(19) United States
(12) Patent Application Publication
(10) Pub. No.: US 2018/0051566 A1
(43) Pub. Date: Feb. 22, 2018

(54) AIRFOIL FOR A TURBINE ENGINE WITH A POROUS TIP

(71) Applicant: General Electric Company, Schenectady, NY (US)

(72) Inventor: Ronald Scott Bunker, Placitas, NM (US)

(21) Appl. No.: 15/238,211

(22) Filed: Aug. 16, 2016

(51) Int. Cl. F01D 5/18; F01D 5/28; F01D 25/12; F01D 9/04; F02K 3/06

(52) U.S. Cl. CPC F01D 5/183; F01D 5/187; F01D 5/28; F01D 25/12; F01D 9/041; F02K 3/06; F05D 2260/22141; F05D 2230/30; F05D 2240/301; F05D 2240/307; F05D 2250/185; F05D 2260/232; F05D 2220/323

(57) ABSTRACT

An apparatus and method for cooling an engine airfoil, including a wall bounding an interior extending axially between a leading edge and a trailing edge and radially between a root and a tip. A cooling circuit it located within the interior having full-length ribs, partial-length ribs, passages, or channels can define a cooling circuit for providing a flow of cooling fluid through the airfoil. The tip can include a tip cap forming a portion of the cooling circuit.

### BACKGROUND OF THE INVENTION

Turbine engines, and particularly gas or combustion turbine engines, are rotary engines that extract energy from a flow of combusted gases passing through the engine onto a multitude of rotating turbine blades.

Turbine engines for aircraft, such as gas turbine engines, are often designed to operate at high temperatures to maximize engine efficiency, so cooling of certain engine components, such as the high-pressure turbine and the low-pressure turbine, can be beneficial. Typically, cooling is accomplished by ducting cooler air from the high and/or low-pressure compressors to the engine components that require cooling. Temperatures in the high-pressure turbine are around 1000° C. to 2000° C. and the cooling air from the compressor is around 500° C. to 700° C. While the compressor air is a high temperature, it is cooler relative to the turbine air, and can be used to cool the turbine.

Contemporary turbine components, such as airfoil blades, can include one or more interior cooling circuits for routing the cooling air through the blades to cool different portions of the blades, and can include dedicated cooling circuits for cooling different portions of the blades, such as the leading edge, trailing edge, or tip.

### BRIEF DESCRIPTION OF THE INVENTION

In one aspect, embodiments of the invention relate to an airfoil for a turbine engine. The airfoil includes a wall defining an interior and an exterior, including a pressure side and a suction side extending axially between a leading edge and a trailing edge defining a chord-wise direction and extending radially between a root and a tip defining a span-wise direction. The airfoil further includes a cooling passage disposed in the interior extending in the span-wise direction to the tip. A porous material is provided on at least a portion of the tip and fluidly coupled to the cooling passage.

In another aspect, embodiments of the invention relate to a component for a turbine engine. The component includes a wall extending radially between a root and a tip. The component further includes a cooling circuit located within the component having a cooling passage extending toward the tip. A porous material is provided on at least a portion of the tip and fluidly coupled to the cooling passage.

In yet another aspect, embodiments of the invention relate to a method of cooling a tip of an airfoil. The method includes passing a flow of cooling fluid through a cooling passage in a span-wise direction toward the tip and passing at least a portion of the flow of cooling fluid through a porous material based upon a porosity of the porous material.

### BRIEF DESCRIPTION OF THE DRAWINGS

In the drawings:

FIG. 1 is a schematic cross-sectional diagram of a turbine engine for an aircraft.

FIG. 2 is a perspective view of an airfoil of the turbine engine of FIG. 1.

FIG. 3 is a cross-sectional view of the airfoil of FIG. 2 illustrating ribs defining passages within an interior of the airfoil.

FIG. 4 is a top-down view of the airfoil of FIG. 3 illustrating a tip cap having a porous material forming a portion of the tip cap.

FIG. 5 is a cross-sectional view of the airfoil of FIG. 4 including a partial-length rib, to define a tip turn, with the porous material disposed in the tip turn.

FIG. 6 is a top-down view of the airfoil of FIG. 2 having porous material forming the tip cap at a trailing edge of the airfoil.

FIG. 7 is a cross-sectional view of the airfoil of FIG. 6 with the porous material forming a tip flag.

FIG. 8 is a cross-sectional view of the airfoil of FIG. 6 including a tip passage and having the porous material forming a portion of the tip passage at the trailing edge.

### DESCRIPTION OF EMBODIMENTS OF THE INVENTION

The described embodiments of the present invention are directed to a blade for a gas turbine engine. For purposes of illustration, the present invention will be described with respect to the blade for an aircraft gas turbine engine. It will be understood, however, that the invention is not so limited and may have general applicability within an engine, including compressors, as well as in non-aircraft applications, such as other mobile applications and non-mobile industrial, commercial, and residential applications. Additionally, the aspects will have applicability outside of a blade, and can extend to any engine component requiring cooling, such as a vane, shroud, or a combustion liner in non-limiting examples.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

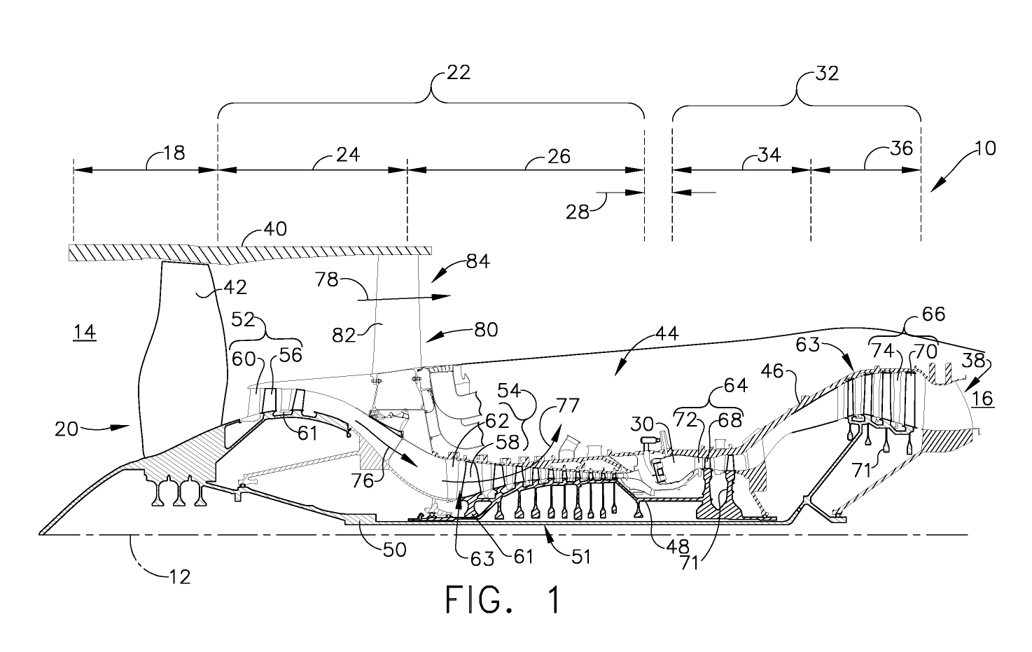

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized airflow 76 to the HP compressor 26, which further pressurizes the air. The pressurized airflow 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be draw from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

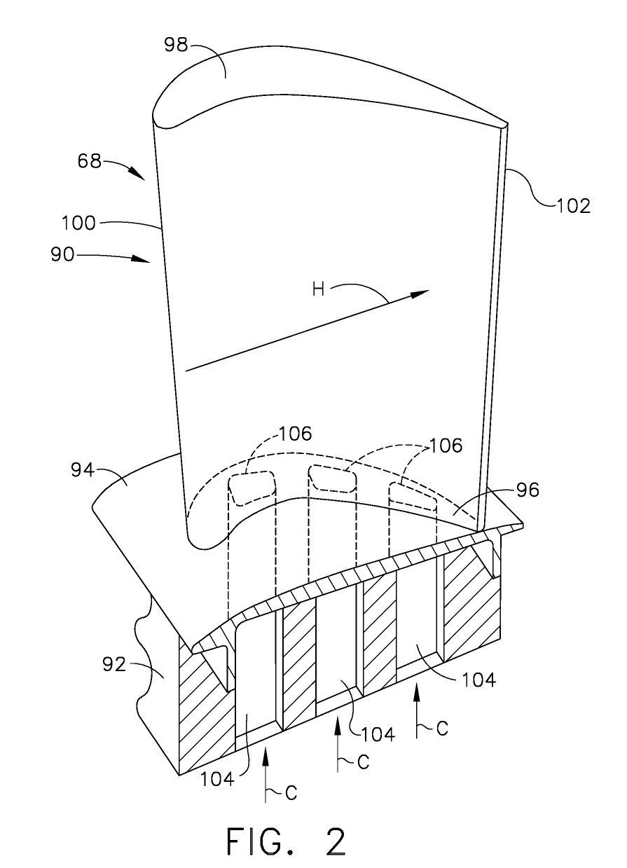

Referring now to FIG. 2, an engine component is shown in the form of an airfoil 90, which can be one of the turbine blades 68 of the engine 10 of FIG. 1. Alternatively, the engine component can include a vane, a shroud, or a combustion liner in non-limiting examples, or any other engine component that can require or utilize cooling. The airfoil 90 includes a dovetail 92 and a platform 94. The airfoil 90 extends radially between a root 96 and a tip 98 defining a span-wise direction. In the case of a shrouded airfoil, the tip 98 can be the furthest radial extend to the airfoil from the engine centerline 12 (FIG. 1). The airfoil 90 extends axially between a leading edge 100 and a trailing edge 102 defining a chord-wise direction. The dovetail 92 can be integral with the platform 94, which can couple to the airfoil 90 at the root 96. The dovetail 92 can be configured to mount to a turbine rotor disk 71 on the engine 10 (FIG. 1). The platform 94 helps to radially contain the turbine airflow. The dovetail 92 comprises at least one inlet passage 104, shown as three inlet passages 104, each extending through the dovetail 92 in fluid communication with the airfoil 90 at a passage outlet 106. It should be appreciated that the dovetail 92 is shown in cross-section, such that the inlet passages 104 are housed within the dovetail 92.

It should be appreciated that in additional components that are not airfoils 90, the tip 98 can be defined at a terminal end of the component, such as at an end of a serpentine cooling circuit, where the circuit turns, in one non-limiting example.

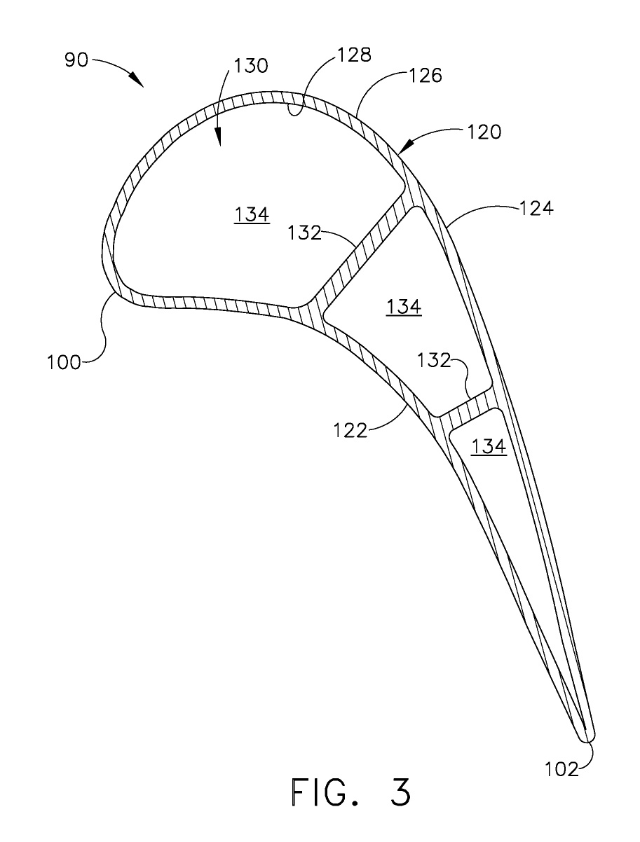

Referring now to FIG. 3, a cross-sectional view of the airfoil 90 illustrates an outer wall 120 including a pressure side 122 and a suction side 124 extending between the leading edge 100 and the trailing edge 102. The outer wall 120 separates the hot fluid flow H external of the airfoil 90 from the cooling fluid flow C within the airfoil 90, having a hot surface 126 along the exterior of the airfoil 90 and a cooling surface 128 confronting the cooling fluid flow C. An interior 130 of the airfoil 90 is defined by the outer wall 120. One or more internal ribs 132 separates the interior 130 into cooling passages 134 extending in the span-wise direction. The passages 134 can define one or more cooling circuits throughout the airfoil 90. Additionally, the cooling circuits can be further includes micro-circuits, sub-circuits, near wall cooling circuits, leading edge passages, trailing edge passages, pin fins, pin banks, additional passages 134, flow enhancers such as turbulators, or any other structures which can define the cooling circuits.

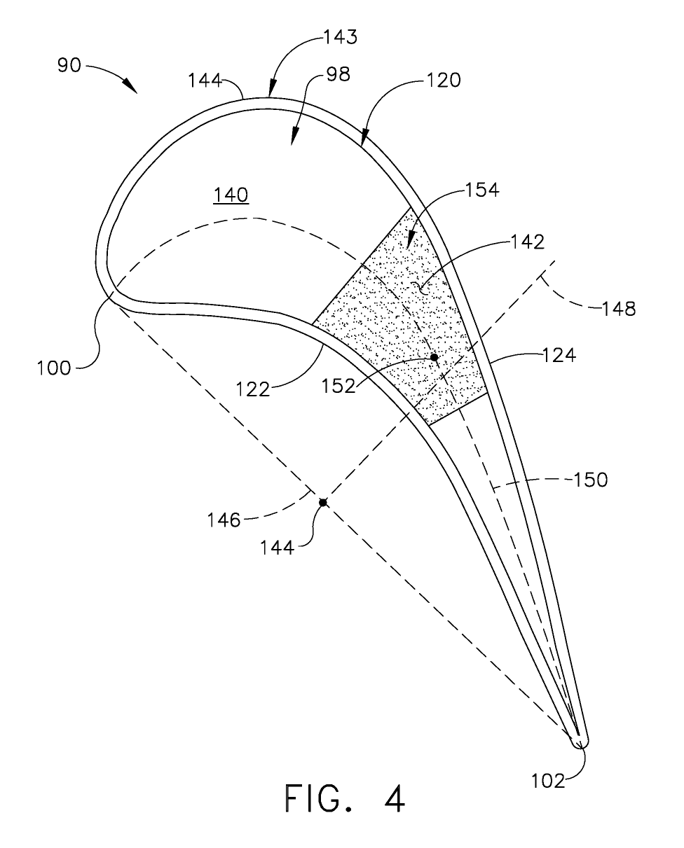

Referring now to FIG. 4, a top-down view of the airfoil 90 illustrates a tip cap 140 enclosing the airfoil 90 at the tip 98. A porous material 142 forms at least a portion of the tip cap 140. Tip edge 143 can be an extension of the outer wall 120 extending above the tip cap 140 forming the edges of the tip cap 140. The porous material 142, for example, can be disposed at a mid-chord 144 where a chord 146 is a straight line drawn from the leading edge 100 to the trailing edge 102. Where the mid-chord 144 extends external of the airfoil 90, the mid-chord position for placing the porous material 142 can be along a line 148 perpendicular to the chord-line 146 from the mid-point 144 of the chord, into the airfoil 90. In another example, the airfoil 90 can form a camber line 150 as the line along the center position between the pressure side 122 and suction side 124 extending from the leading edge 100 to the trailing edge 102. The porous material 142 can be disposed at a center 152 of the camber line 150. It should be appreciated that the porous material 142 can be positioned anywhere along the tip cap 140, such as any position along the chord-line 146 or the camber line 148.

The porous material can 142 can form an area 154 of the tip cap 140. The area 154 can extend fully between the pressure side 122 and the suction side 124. Additionally, the area 154 can form multiple discrete areas 154 along the tip cap 140. Alternatively, the area 154 can extend only partially between the pressure side 122 and the suction side 124, being adjacent to either side 122, 124 or spaced therefrom. As such, it should be appreciated that the area 154 of the porous material 142 forming the tip cap 140 can form discrete shapes, or profiles, as cross-sectional areas 154. Such shapes or profiles can be determined by the particular needs to the airfoil 90 or the tip 98. Such shapes or profiles, in non-limiting examples, can include geometrical shapes, rectilinear shapes, curvilinear shapes, unique shapes, or any combination thereof. Furthermore, the multiple discrete areas 154 can be discretely shaped, or similarly shaped, in non-limiting examples. The porous material can be formed in the tip cap 140, forming as least a portion of the boundary walls of the tip cap 140 or an adjacent passage. Formed in the in the tip cap 140 should not be construed as limiting to the interior of the tip cap 140 or adjacent passage.

The porous material 142 can be porous such that no single flow passage exists without interconnection to another flow passage, from ingress to egress of the fluid passing through the porous material 142. A particular closed region within the porous material 142, however, may not interconnect to another passage within the porous material 142. Additionally, the porous material 142 can be the mean free path length of the flow is much greater than the geometric length for a discrete hole extending fully through the material. In a further non-limiting example, the porosity of the porous material 142 can include porous holes less than 0.005 inches for a random porous material and with deterministic sizes of 0.005 inches and less for a structured porous material. It should be appreciated that many different sizes can be included to meter the flow through the porous materials 142.

The porous material 142 can be made by additive manufacturing, while it is contemplated that additive manufacturing can form the entire airfoil 90. It should be appreciated that any portion of the airfoil 90 can be made by any known method including but not limited to, casting, machining, additive manufacturing, coating, or otherwise. The porous material 142 can define a porosity, being permeable by a volume of fluid, such as air. Additionally, the porous material 142 can be alternatively defined as a region having no single flow passage without interconnection among another flow passage. The porous material 142 can have a particular porosity to meter the flow of a fluid passing through the porous material 142 at a predetermined rate. It should be appreciated that additive manufacturing can be used to achieve a particular local porosity along the porous material 142, as well as a consistent porosity across the entirety of the porous material 142, as compared to traditional method of forming the porous material 142. In alternative examples, the porous material 142 can be made of any of the materials described above, such that a porosity is defined. In one non-limiting example, the porous material 142 can be made of Ni, NiCrAlY, NiAl, or similar materials. The porous material 142 can further be made of a nickel foam, for example.

Additionally, the porous material 142 can be a structured porous material or a random porous material, or any combination thereof. A structured porous material includes a determinative porosity throughout the material, which can have particular local increases or decreases in porosity to meter a flow of fluid passing through the structured porous material. Such local porosities can be determined and controlled during manufacture. Additive manufacturing can be used to form a structured porous material, in one non-limiting example. Alternatively, the porous materials can have a random porosity. The random porosity can be adapted to have a porosity as the average porosity over an area or volume of the porous material 142, having discrete variable porosities that are random. A random porous material can be made from a nickel foam, in one non-limiting example.

In one non-limiting example, the porosity can have an average pore size of less than 0.005 inches for a random porous material and a deterministic 0.005 inches or less for a structure porous material.

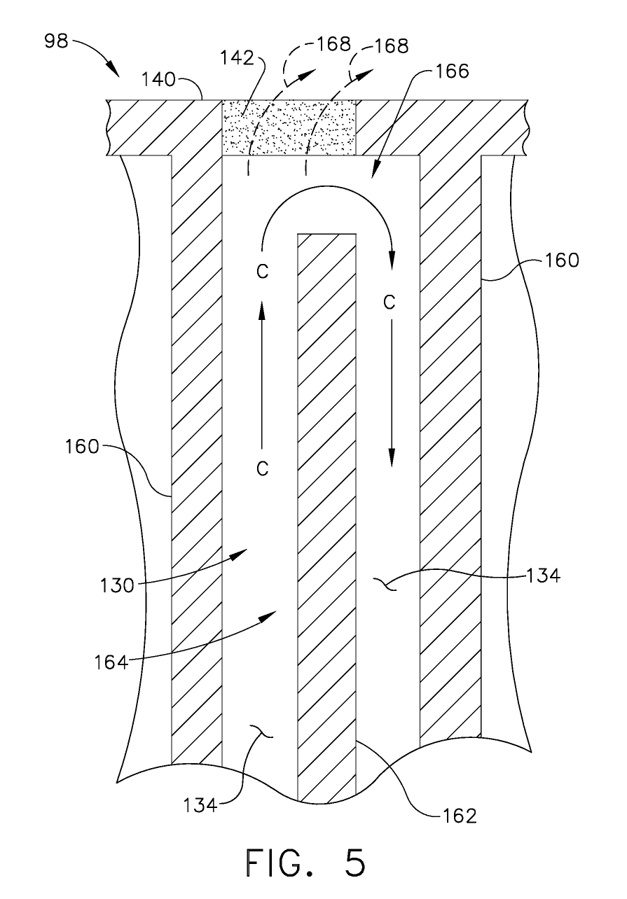

Referring to FIG. 5, an exemplary cross-sectional view of the airfoil of FIG. 4 includes the internal ribs 132 as two full-length ribs 160 and one partial-length rib 162 disposed between the full-length ribs 160. The passages 134 are defined between the ribs 132. A cooling circuit 164 can be formed by the passages 134 for providing the cooling fluid flow C throughout the interior 130 of the airfoil 90. The partial-length ribs 162 organized between the full-length ribs 160 define the cooling circuit 164, having a substantially serpentine flow path as illustrated. It should be understood that the cooling circuit 164 as illustrated is exemplary, and can include additional structures to form the cooling circuit 164, such as micro-circuits, sub-circuits, near wall cooling circuits, leading edge passages, trailing edge passages, pin fins, pin banks, additional passages 134, or flow enhancers such as turbulators in non-limiting examples. A tip turn 166 is formed by the partial-length rib 162 adjacent the tip cap 140, and forms a portion of the cooling circuit 164.

The porous material 142 can be disposed in the tip cap 140 at the tip turn 166. The cooling fluid flow C can be provided within the cooling circuit 164 through the passages 134 and to the tip turn 166. At least a portion of the cooling fluid flow C can be exhausted through the porous material 142 in the tip cap 140 as a tip flow 168. The porous material 142 can be disposed in the tip cap 140 for the entirety of the tip turn 166 or for a portion of the tip turn 166. The tip flow 168 can form a cooling film along the tip 98 of the airfoil 90, as well as maintain pressure within a tip cavity of the airfoil to maintain tip pressures.

In the example where the component is not an airfoil 90, the tip 98 can be toward the end of a serpentine cooling circuit, such as the cooling circuit 164 having a substantially serpentine flow path. The serpentine cooling circuit can be located in the component to define a turn, such as the tip turn 166 at the end of one or more cooling passages 134. The tip can be defined at the turn, such as the tip turn 166. The porous material 142 can define a portion of the tip 98 and fluidly couple to the cooling passages 134. In such a component, the porous material 142 can span the tip 98, extending from both sides of the component. Additionally, the component can include a rib such as the partial-length rib 162 to at least partially define the serpentine cooling circuit as well as the turn 166. The porous material 142 can be spaced from the partial-length rib 162, such as aligned with the partial-length rib 162, or disposed at the shortest distance from the partial-length rib 162 to the tip 98, in non-limiting examples.

Additionally, the serpentine cooling circuit 164 can be disposed adjacent the aft edge 102 (FIG. 4) of the component or the tip 98. The porous material 142 can at least partially define the aft edge 102 and the tip 98, or a junction between the two.

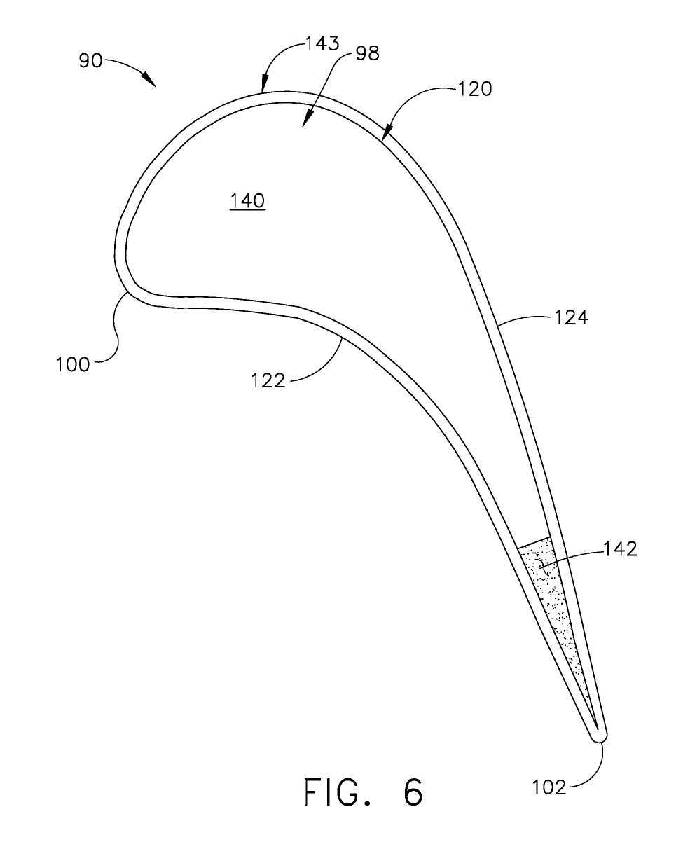

Referring now to FIG. 6, another exemplary tip 98 of the airfoil 90 can include the porous material 142 disposed along the tip cap 140 adjacent the trailing edge 102. The porous material 142, similar to that of FIG. 4, can extend between the pressure and suction sides 122, 124, as well as form any shape or have any cross-sectional area. It should be appreciated that the porous material 142 can also be disposed adjacent the leading edge 100, as well as at multiple positions on the tip cap 140, such as at both the leading edge 100 and the trailing edge 102 in one non-limiting example, and should not be limited as shown in FIGS. 4 and 6.

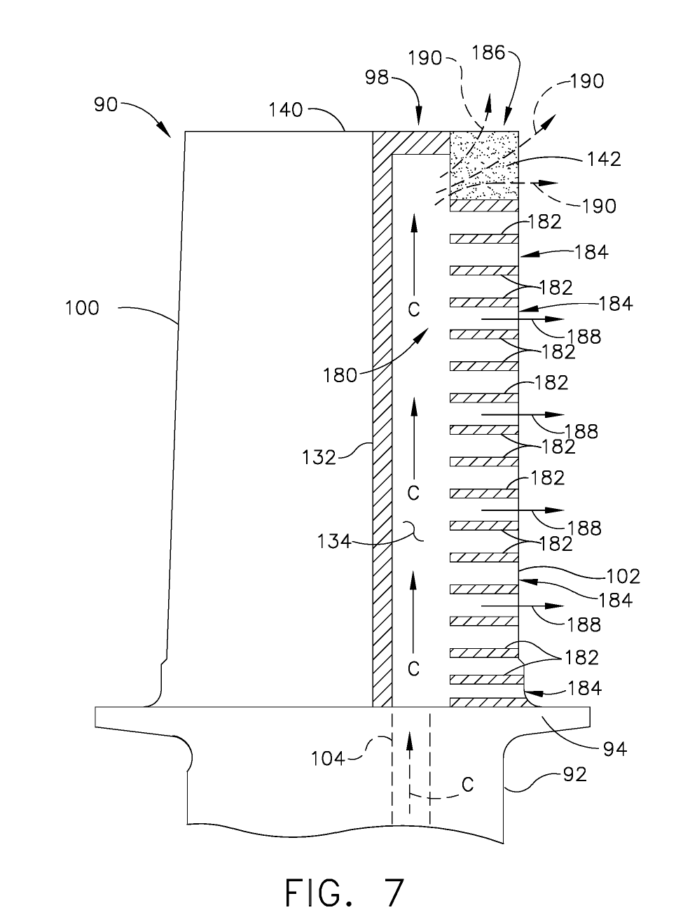

Referring now to FIG. 7, a trailing edge cooling circuit 180 can be formed along the trailing edge 102. The trailing edge cooling circuit 180 can include the passage 134, at least partially defined by the rib 132, extending in the span-wise direction.

A plurality of trailing edge ribs 182 can be disposed in span-wise arrangement along the trailing edge 102 defining a plurality of trailing edge ejection holes 184. The trailing edge ejection holes 184 can also be elongated, shaped as slots. A tip flag 186 can be disposed along the tip cap 140 at the trailing edge 102. The tip flag 186 can be at least partially formed of the porous material 142. The trailing edge ejection holes 184 and the tip flag 186 can further define the trailing edge cooling circuit 180.

The flow of cooling fluid C can be provided to the trailing edge cooling circuit 180 through the inlet passage 104 in the dovetail 92. The flow of cooling fluid C can be exhausted through the trailing edge 102 at the trailing edge ejection holes 184 as a first exhaust flow 188. Additionally, the cooling fluid flow C can be exhausted through the tip flag 186 as a second exhaust flow 190, which can exhaust through the tip flag 186 at the tip 98, the trailing edge 102, or a combination thereof.

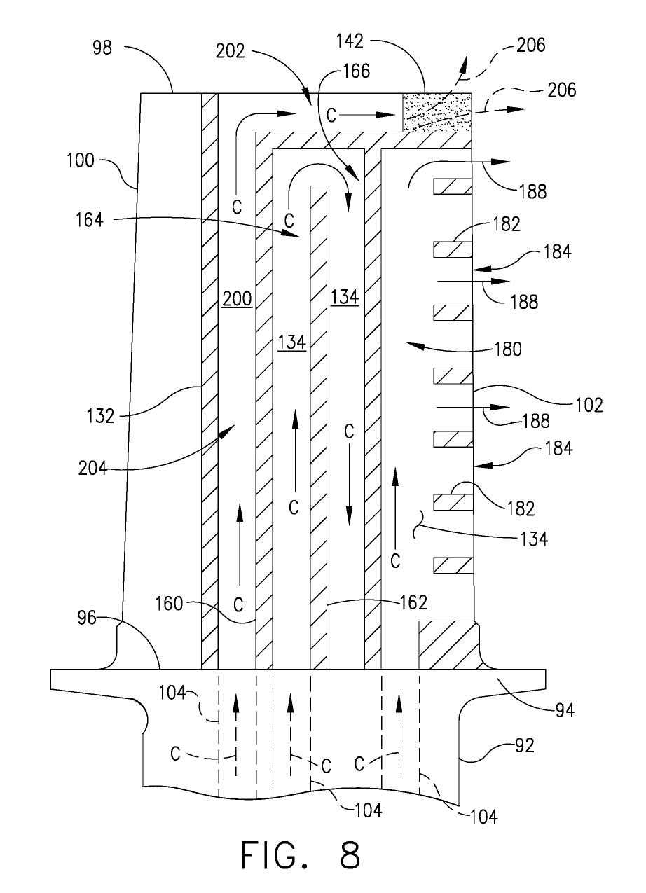

Referring now to FIG. 8, the airfoil 90 can include the cooling circuit 164 of FIG. 5 and the trailing edge cooling circuit of 180, having the cooling circuits 164, 180 terminate radially inward of the tip 98. A full-length passage 200 can extend from the root 96 to the tip 98, coupling to a tip passage 202 extending chord-wise along the tip 98 of the airfoil 90 to the trailing edge 102. The full-length passage 200 and the tip passage 202 can form a tip cooling circuit 204. The tip passage 202 can include the porous material 142 forming a portion of the tip passage 202. The porous material 142 can extend through the entire span-wise length of the tip passage 202, or can extend partially therethrough. The porous material 142 can be positioned adjacent the trailing edge 102, in one example. In another example, the porous material 142 can be positioned along the tip passage 202 and spaced from the trailing edge 102, such as the middle of the tip passage 202 or adjacent the full-length passage 200. It should be appreciated that the cooling circuit pattern, or layout, as shown is exemplary, and numerous cooling circuits 164 varying from the exemplary embodiment are contemplated.

Alternatively, in the implementation in an engine component other than an airfoil, the tip passage 202 can extend along the tip 98 defined near the end of a serpentine cooling circuit 164 or the turn 166, with the tip passage in fluid communication with the porous material 142 and forming at least a portion of the tip 98.

In operation, the flow of cooling fluid C is provided to the full-length passage 200 from one of the inlet passage 104 in the dovetail 92. The flow of cooling fluid C within the full-length passage 200 can move in a substantially span-wise or radial direction. The full-length passage 200 feeds the tip passage 202, where the cooling fluid flow C turns from a radial direction to a substantially axial or chord-wise direction, moving toward the trailing edge 102. The flow of cooling fluid C is provided to the porous material 142, where it can be exhausted from the tip passage 202 as a third exhaust flow 206, through the tip 98, the trailing edge 102, or a combination thereof.

Additionally, while it is shown that the tip passage 202 is fed from the full-length passage 200, it is contemplated that the tip passage 202 can be fed from another cooling circuit 164, 180, or that the cooling circuits can be integrated into a single cooling circuit defined throughout the airfoil 90.

A method of cooling a tip of an airfoil can include (1) passing flow of cooling fluid through a cooling passage in a span-wise direction toward the tip and (2) passing at least a portion of the flow of cooling fluid through a porous material located in the tip. Passing the cooling fluid can include passing the flow of cooling fluid C in the passages 134, 200 shown in FIG. 5, 7, or 8, moving toward the tip 98. The porous material can be the porous material 142 as described and shown in FIG. 5, 7, or 8.

Additionally, the method can include exhausting the flow of cooling fluid from the porous material. Such an exhausted cooling fluid flow can be the second or third exhaust flows 190, 206 of FIG. 7 or 8, or can be the tip flow 168 of FIG. 5. Additionally, the method can include exhausting the cooling fluid from at least one of the tip 98 or the trailing edge 102 of the airfoil 90. Furthermore, the method can include metering the flow of cooling fluid C through the porous material 142 based upon the porosity of the porous material 142. For example, the porous material 142 can be a structured porous material 142, made by additive manufacturing, having a local determinative flow by having discrete porosities throughout the porous material 142. As such, the cooling fluid flow C can be metered locally based upon the particular local porosity. Alternatively, the flow C can be metered by an average porosity throughout the porous material 142, such as having a random porosity being made by a nickel foam.

It should be appreciated that the porous material 142, as described herein provides for improved airfoil cooling at the tip 98 of the airfoil 90, particularly, adjacent tip turns 166 or at the trailing edge 102. The porous portions 142 permit a volume of cooling air to pass through the tip cap 140 to provide a particular cooling fluid C passing through the tip 98 from an interior airfoil cooling circuit. Additionally, the porous material 142 can be used to increase or maintain structural integrity of the airfoil 90, while maintaining or decreasing system weight without sacrificing cooling efficiency, or even improving the cooling efficiency. The porous material 142 can be significantly lighter than the other portions or materials used in constructing the airfoil 90.

It should be appreciated that while the description is directed toward a trailing edge of the airfoil, the concepts as described herein can have equal applicability in additional engine components, such as a blade, vane, or other airfoil-shaped elements, such as a strut or outlet guide vane, and can be any region of any engine component requiring cooling, such as regions typically requiring film cooling holes or multi-bore cooling. For example, the porous portions could be placed in the endwalls and platforms or other components.

It should be further appreciated that the porous material 142 can provide for improved film cooling, or tip pressure maintenance, such as providing improved directionality, metering, or local flow rates.

It should be appreciated that application of the disclosed design is not limited to turbine engines with fan and booster sections, but is applicable to turbojets and turbo engines as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An airfoil for a turbine engine, the airfoil comprising:
a wall defining an interior and an exterior for the airfoil, including a pressure side and a suction side extending axially between a leading edge and a trailing edge defining a chord-wise direction and extending radially between a root and a tip defining a span-wise direction;
a cooling passage disposed in the interior extending in the span-wise direction to the tip; and
a porous material defining at least a portion of the tip and fluidly coupled to the cooling passage.

2. The airfoil of claim 1 further comprising a tip cap at least partially defining the tip with the porous material defining the tip cap.

3. The airfoil of claim 1 further comprising a tip turn with the cooling passage terminating at the tip turn and having the porous material defining the tip at the tip turn.

4. The airfoil of claim 3 wherein the porous material is disposed at least partially at a mid-chord.

5. The airfoil of claim 1 further comprises a tip flag fluidly coupled to the cooling passage having the porous material at least partially forming the tip flag.

6. The airfoil of claim 1 further comprising a tip passage extending in the chord-wise direction in fluid communication with the cooling passage having the porous material defining at least a portion of the tip passage.

7. The airfoil of claim 6 wherein the porous material is located at a mid-chord.

8. The airfoil of claim 6 wherein the porous material is located adjacent the trailing edge.

9. The airfoil of claim 1 wherein the porous material is structured porous material formed by additive manufacturing.

10. A component for a turbine engine, the component comprising:
a serpentine cooling circuit located within the component defining a turn and having at least one cooling passage defining the serpentine cooling circuit;
a tip of the component located at the turn;
a porous material defining at least a portion of the tip and fluidly coupled to the cooling passage.

11. The component of claim 10 wherein the porous material spans the tip.

12. The component of claim 11 further comprising a partial-length rib partially defining the turn, and the porous material is spaced from the partial-length rib.

13. The component of claim 10 wherein the serpentine cooling circuit defines an aft cooling circuit including an aft edge of the tip with the porous material at least partially defining the aft edge.

14. The component of claim 10 further comprising a tip passage extending along the tip and at least partially defining the tip with the tip passage in fluid communication with the cooling passage and having the porous material at least partially defining the tip passage.

15. The component of claim 14 wherein the porous material fills a cross-sectional area of the tip passage.

16. The component of claim 10 wherein the porous material is structured porous material.

17. The component of claim 16 wherein the porous material is formed by additive manufacturing.

18. A method of cooling a tip of an airfoil, the method comprising:
passing a flow of cooling fluid through a cooling passage in a span-wise direction toward the tip; and
passing at least a portion of the flow of cooling fluid through a porous material located in the tip.

19. The method of claim 18 further comprising exhausting the flow of cooling fluid from the porous material.

20. The method of claim 19 wherein the flow of cooling fluid is exhausted from at least one of the tip or a trailing edge of the airfoil.

21. The method of claim 18 further comprising metering the flow of cooling fluid through the porous material based upon a porosity of the porous material.
